(19) United States
(12) Patent Application Publication
(10) Pub. No.: US 2024/0362930 A1
(43) Pub. Date: Oct. 31, 2024

(54) SKELETON BASED DRIVER MONITORING

(71) Applicant: InCarEye Ltd, Ramat Gan (IL)

(72) Inventor: Shlomi OPHIR, Tel Aviv (IL)

(73) Assignee: InCarEye Ltd, Ramat Gan (IL)

(21) Appl. No.: 18/139,971

(22) Filed: Apr. 27, 2023

(51) Int. Cl. G06V 20/59; G06T 7/20; G06V 20/52; G06V 40/20

(52) U.S. Cl. CPC G06V 20/597; G06T 7/20; G06V 20/52; G06V 40/20; G06T 2207/20044; G06V 2201/07

(57) ABSTRACT

There is provided a computer implemented method of monitoring an occupant of a vehicle, comprising: computing a target movement vector set of a skeleton representation from a target video captured by a camera oriented towards a side of the occupant, feeding the target movement vector set of the target skeleton representation into a personalized ML model, obtaining a likelihood of the occupant about to perform an unsafe action as an outcome of the personalized ML model, and generating a feedback by a user interface device in response to the outcome, the feedback generated prior to the occupant performing the unsafe action, thereby preventing the occupant from performing the unsafe action, wherein the personalized ML model is trained on sequences of personalized motions performed by the occupant prior to the performance of the unsafe action and ground truth labels indicating the unsafe action.

### FIELD AND BACKGROUND OF THE INVENTION

The present invention, in some embodiments thereof, relates to machine learning models and, more specifically, but not exclusively, to ML models for monitoring occupants of a vehicle. Certain actions performed by occupants (e.g., drivers and/or passengers) while driving distract the driver's attention away from the road, creating a dangerous situation in which the driver is at higher risk of getting into accidents.

### SUMMARY OF THE INVENTION

According to a first aspect, a computer implemented method of monitoring an occupant of a vehicle, comprises: computing a target movement vector set of a skeleton representation from a target video captured by a camera oriented towards a side of the occupant, feeding the target movement vector set of the target skeleton representation into a personalized ML model, obtaining a likelihood of the occupant about to perform an unsafe action as an outcome of the personalized ML model, and generating a feedback by a user interface device in response to the outcome, the feedback generated prior to the occupant performing the unsafe action, thereby preventing the occupant from performing the unsafe action, wherein the personalized ML model is trained on sequences of personalized motions performed by the occupant prior to the performance of the unsafe action and ground truth labels indicating the unsafe action.

According to a second aspect, a computer implemented method of monitoring an occupant of a vehicle, comprises: creating a personalized machine learning (ML) model for the occupant by: monitoring a movement vector set of a skeleton representation of the occupant computed from a training video captured by a camera oriented towards a side of the occupant, detecting an unsafe action performed by the occupant, creating a record comprising a sequence of motions performed by the movement vector set of the skeleton representation prior to the performance of the unsafe action, and a ground truth label indicating the unsafe action, training the personalized ML model on the record, computing a target movement vector set of the skeleton representation from a target video captured by the camera, feeding the target movement vector set of the target skeleton representation into the personalized ML model, and obtaining a likelihood of the occupant about to perform the unsafe action as an outcome of the personalized ML model.

According to a third aspect, a computer implemented method of creating a personalized ML model for an occupant of a vehicle, comprises: monitoring a movement vector set of a skeleton representation of the occupant computed from a training video captured by a camera oriented towards a side of the occupant, detecting an unsafe action performed by the occupant, creating a record comprising a sequence of motions performed by the movement vector set of the skeleton representation prior to the performance of the unsafe action, and a ground truth label indicating the unsafe action, and training the personalized ML model on the record, wherein a likelihood of the occupant about to perform the unsafe action is obtained as an outcome of the personalized ML model in response to an input of a target movement vector set of the skeleton representation computed from a target video captured by the camera.

In a further implementation form of the first, second, and third aspects, the personalized ML model for the occupant is created by: monitoring the movement vector set of the skeleton representation of the occupant depicting the personalized motions performed by the occupant, computed from a training video captured by the camera, detecting the unsafe action performed by the occupant, creating a record comprising a sequence of personalized motions performed by the occupant as depicted in the movement vector set of the skeleton representation prior to the performance of the unsafe action, and the ground truth label indicating the unsafe action, and training the personalized ML model on the record.

In a further implementation form of the first, second, and third aspects, the unsafe action is automatically detected by an unsafe ML model trained for analyzing movement vector sets of skeleton representations of occupants, and the ground truth label is automatically created based on the automatically detected unsafe action.

In a further implementation form of the first, second, and third aspects, the likelihood of the occupant about to perform the unsafe action is obtained prior to the occupant performing the unsafe action.

In a further implementation form of the first, second, and third aspects, further comprising, creating another record comprising the sequence of motions performed by the movement vector set of the skeleton representation after the generation of the feedback and the ground truth label indicating avoidance of the unsafe action, and monitoring the outcome of the personalized ML model to obtain the outcome indicating that the occupant has avoided the unsafe action in response to the feedback.

In a further implementation form of the first, second, and third aspects, creating the personalized ML model and the feeding, and the obtaining are performed substantially simultaneously, and/or sequentially and/or alternatively.

In a further implementation form of the first, second, and third aspects, further comprising: detecting a safe action performed by the occupant, creating another record comprising the sequence of motions performed by the movement vector set of the skeleton representation prior to the performance of the safe action, and a ground truth label indicating the safe action, and training the personalized ML model on the safe action.

In a further implementation form of the first, second, and third aspects, the unsafe action is selecting from a group comprising: using and/or touching a mobile device, reading, drinking, eating, taking hands off a wheel, turning a head of the occupant away from the road, disturbing the driver, touching the steering wheel, touching the gears, putting a hand out the window, leaving a child in the car after occupants have exited the car, unsafe seating position, unruly behavior, detected carjacking, detected criminal acts, physical attack by one occupant on another occupant, emergency medical state, and placing feet on a dashboard, driving for long periods of time without a break, forgetting an object in the vehicle, and/or driving while one or more of: drunk, high on drugs, tired, stressed, agitated, anxious, nervous, and/or uncomfortable.

In a further implementation form of the first, second, and third aspects, the personalized ML model is created by applying a transfer learning approach by training a generic ML model on a record created for the occupant, the generic ML model trained on a generic training dataset of records obtained from other sample subjects performing a same type of unsafe action.

In a further implementation form of the first, second, and third aspects, the movement vector set depicts the occupant during operation of the vehicle, the unsafe action is performed by the occupant during operation of the vehicle, the ground truth further includes a second label indicating that the unsafe action is performed during operation of the vehicle, and the likelihood of the occupant about to perform the unsafe action is while the occupant is operating the vehicle.

In a further implementation form of the first, second, and third aspects, further comprising creating another record comprising a sequence of motions performed by the movement set while the occupant is not operating the vehicle, prior to the occupant performing a sample action which is the unsafe action while the occupant is operating the vehicle and a safe action when the occupant is non-operating the vehicle, and a ground truth label indicating a safe action, wherein the safe action is obtained as the outcome of the personalized ML model when the target movement vector set of the target video depicts the occupant not operating the vehicle.

In a further implementation form of the first, second, and third aspects, while the occupant is not operating the vehicle comprises at least one of: the occupant is stopping the vehicle, and while the vehicle is stopped.

In a further implementation form of the first, second, and third aspects, the camera is installed at a right corner of a cabin of the vehicle between a windshield and a passenger door, above a head level of a passenger and the occupant.

In a further implementation form of the first, second, and third aspects, the camera captures a full body of the occupant, wherein the movement vector set of the skeleton representation depicts arms, torso, and legs of the occupant.

In a further implementation form of the first, second, and third aspects, the full body of the occupant includes fingers of the occupant, and the movement vector of the skeleton representation depicts one or more fingers of the occupant, and further comprising analyzing the training video for detecting an object, wherein the unsafe action comprises the occupant's fingers interacting with the object, wherein the sequence of a record is prior to the occupant's fingers interacting with the object, wherein the ground truth label further indicates the detected object, wherein the outcome of the personalized ML model is likelihood of the occupant's fingers about to interact with the object.

In a further implementation form of the first, second, and third aspects, the record further comprises a portion of the training video corresponding to the sequence of motions, and wherein feeding further comprises feeding the target video into the personalized ML model.

In a further implementation form of the first, second, and third aspects, a record excludes features enabling recognizing a face of the occupant, wherein features enabling recognizing the face of the occupant are not fed into the personalized ML model.

In a further implementation form of the first, second, and third aspects, the sequence of motions of a record depict the occupant touching an object, and wherein the outcome of the personalized ML model is generated in response to the occupant touching the object depicted in the target movement vector set fed into the personalized ML model.

In a further implementation form of the first, second, and third aspects, the sequence of motions of the record and/or fed into the personalized ML model exclude a depiction of the object and/or exclude an explicit location of the object.

In a further implementation form of the first, second, and third aspects, further comprising creating another record comprising the sequence of motions performed by the movement vector set of the skeleton representation during the unsafe action and the ground truth label indicating performance of the unsafe action, and in response to obtaining an indication of the occupant performing the unsafe action, generating instructions for execution by at least one component of the vehicle for at least one of: (i) warning individuals outside of the vehicle and (ii) reporting performance of the unsafe action to an external computing device.

In a further implementation form of the first, second, and third aspects, further comprising: identifying an occupant profile of a plurality of occupant profiles, and selecting the personalized ML model from a plurality of personalized ML models, each personalized ML model corresponding to a certain occupant profile.

In a further implementation form of the first, second, and third aspects, further comprising: obtaining measurements by one or more sensors indicating a state of the vehicle and/or monitoring a state of the occupant, and feeding comprises feeding a combination of the measurements and the target movement vector set into the personalized ML model, wherein the personalized ML model is trained on records that include the combination of the measurements and the target movement vector set.

In a further implementation form of the first, second, and third aspects, further comprising generating instructions for automatic adjustment of one or more vehicle settings for reducing likelihood of the occupant performing the unsafe action by improving the state of the vehicle to increase attention of the occupant.

According to a fourth aspect, a computer implemented method of personalizing a vehicle for an occupant, comprises: computing a target movement vector set of a skeleton representation from a target video captured by a camera oriented towards a side of the occupant, feeding the target movement vector set of the target skeleton representation into a personalized ML model, obtaining an occupant profile for the occupant as an outcome of the personalized ML model, and generating instructions for personalizing one or more parameters of the vehicle for the occupant according to the occupant profile, wherein the personalized ML model is trained on sequences of personalized motions performed by the occupant and ground truth labels indicating the occupant profile.

In a further implementation form of the fourth aspect, the personalized ML model for the occupant is created by: monitoring the movement vector set of the skeleton representation of the occupant depicting the personalized motions performed by the occupant, computed from a training video captured by the camera, detecting one or more parameters of the occupant profile of the occupant, creating a record comprising a sequence of personalized motions performed by the 30 occupant as depicted in the movement vector set of the skeleton representation, and the ground truth label indicating the one or more parameters of the occupant profile, and training the personalized ML model on the record.

In a further implementation form of the fourth aspect, the record includes the sequence of personalized motions performed by the occupant prior to adapting one or more parameters of the occupant profile, and wherein the outcome of the occupant profile obtained from the ML model is obtained prior to the occupant adapting one or more parameters of the occupant profile, and wherein the instructions for personalizing the one or more parameters of the vehicle for the occupant according to the occupant profile are generated prior to the occupant adapting one or more parameters of the occupant profile.

In a further implementation form of the fourth aspect, the occupant includes a driver of the vehicle, and wherein the computing, the feeding, the obtaining and the generating are iterated while the driver is driving the vehicle.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of components of a system for monitoring an occupant of a vehicle for predicting an unsafe action, and/or for training a personalized ML model(s) for predicting the unsafe action, in accordance with some embodiments of the present invention;

FIG. 2 is a flowchart of a method for monitoring an occupant of a vehicle for predicting an unsafe action, in accordance with some embodiments of the present invention;

FIG. 3 is a flowchart of a method for training a personalized ML model(s) for predicting the unsafe action, in accordance with some embodiments of the present invention; and

FIG. 4 is a flowchart of a method for personalizing a vehicle for an occupant, in accordance with some embodiments of the present invention.

### DESCRIPTION OF SPECIFIC EMBODIMENTS OF THE INVENTION

Certain actions performed by occupants (e.g., drivers and/or passengers) while driving distract the driver's attention away from the road, creating a dangerous situation in which the driver is at higher risk of getting into accidents.

As used herein, the term occupant refers to a driver and/or passenger of a vehicle. The term driver may sometimes be used as an example of the occupant, for example, most likely to perform an unsafe action. The term driver is not meant to be necessarily limiting, as features described with respect to the driver may sometimes be relevant to other occupants such as passengers.

An aspect of some embodiments of the present invention relates to systems, computing devices, methods, and/or code instructions (stored on a data storage device and executable by one or more processors) for monitoring an occupant (e.g., driver and/or passenger(s)) of a vehicle for detecting likelihood of the occupant about to perform an unsafe action, prior to the occupant performing the unsafe action. Examples of unsafe actions for a driver include using and/or touching and/or holding a mobile device, reading, drinking, eating, taking hands off a wheel, and turning a head away from the road. Examples of unsafe actions for a passenger include disturbing the driver, touching the steering wheel, touching the gears, putting a hand out the window, and the like. Examples of other unsafe actions include leaving a child in the car after occupants have exited the car, unsafe seating position, unruly behavior, detected carjacking, detected criminal acts, physical attack by one occupant on another occupant, emergency medical state, and placing feet on the dashboard, driving for long periods of time without a break, forgetting an object in the vehicle, and/or driving while one or more of: drunk, high on drugs, tired, stressed, agitated, anxious, nervous, and/or uncomfortable. Detection of the impending unsafe action may enable taking action for preventing the occupant from performing the unsafe action. Detection of the impending unsafe action and/or taking action for preventing the unsafe action from being performed is in contrast, for example, to prior approaches that detect the unsafe action while it is occurring, and/or after the unsafe action has commenced and/or after the unsafe action has occurred. A processor computes a target movement vector set of a skeleton representation from a target video captured by a camera capturing images of one or more occupants. Optionally, the camera is oriented towards a side of the occupant, for example, the driver and/or passenger(s). The processor feeds the target movement vector set of the target skeleton representation into a personalized machine learning (ML) model. The processor obtains the likelihood of the occupant about to perform an unsafe action as an outcome of the personalized ML model. The processor generates a feedback by a user interface device in response to the outcome, for example, an audio message played over speakers, a pop-up message appearing on the display of the dashboard, an image and/or video appearing on a smartphone of the user located in the vehicle, and the like. The feedback is generated prior to the driver performing the unsafe action, which may alert the deriver. The feedback (e.g., alert) may prevent the driver from performing the unsafe action. The personalized ML model is trained on sequences of personalized motions performed by the driver prior to the performance of the unsafe action and ground truth labels indicating the unsafe action.

An aspect of some embodiments of the present invention relates to systems, computing devices, methods, and/or code instructions (stored on a data storage device and executable by one or more processors) for creating a personalized ML model for an occupant of a vehicle. A processor monitors a movement vector set of a skeleton representation of the occupant computed from a training video captured by a camera capturing images of the occupant, optionally the camera is oriented towards a side of the occupant. The processor detects an unsafe action performed by the occupant. The processor creates one or more records. Each record includes a sequence of motions performed by the movement vector set of the skeleton representation prior to the performance of the unsafe action, and a ground truth label indicating the unsafe action. The personalized ML model is trained on the record(s). A likelihood of the driver about to perform the unsafe action is obtained as an outcome of the personalized ML model in response to an input of a target movement vector set of the skeleton representation computed from a target video captured by the camera.

The personalized ML model enables detecting unique movement of the occupant done prior to the unsafe action, which enables prediction of the unsafe action using the unique movements, prior to occurrence of the unsafe action. For example, the driver tends to scratch their head before reaching for a phone to check messages and/or make a call. Such head scratching may be unique to this driver. The personalized ML model may be used to monitor the driver to detect head scratches, and generate a warning to the driver to remind the driver not to touch the phone. Such movements are personal movements of the driver, which are not generally performed by other drivers. As such, training the ML model on videos of other occupants that do not perform the actions of the specific occupant would not enable predicting that the occupant is about to perform the unsafe action when the personalized movements are detected. In fact, training an ML model using many drivers would “drown out” the personalized movements of specific occupants.

An aspect of some embodiments of the present invention relates to systems, computing devices, methods, and/or code instructions (stored on a data storage device and executable by one or more processors) for personalizing a vehicle for an occupant. A processor computes a target movement vector set of a skeleton representation from a target video captured by a camera oriented towards a side of the occupant. The processor feeds the target movement vector set of the target skeleton representation into a personalized ML model. An occupant profile for the occupant is obtained as an outcome of the personalized ML model. The occupant profile may define one or more settings of parameters of the vehicle that are personalized to the occupant, for example, radio station, volume, type of music, tilt of steering wheel, adjustment of seat (forward, reverse), temperature of air conditioner, seat lumbar support, and/or location of icons on a display in the vehicle. Instructions for personalizing the one or more parameters of the vehicle for the occupant according to the occupant profile, are generated, optionally in real time or near real time. The personalization of the parameters of the vehicle may be set for the occupant according to the real time monitored motions of the occupant, for example, for improved comfort, improved user experience, and/or improved safety. The occupant profile may be iteratively computed and implemented by the generated instructions, for example, for the driver while the driver is driving the vehicle. This may enable real time (or near real time) adaptation to the state of the driver. For example, when the driver is getting tired after a long driving time and makes corresponding motions, the air conditioner's temperature may be reduced in an attempt to wake up the driver. In another example, when the driver reaches a highway, the seat may be moved back to make the highway drive more comfortable. In yet another example, at 5 PM, a music radio station may be changed to a talk show radio station which is enjoyable to the driver.

Optionally, the personalized ML model for the occupant is created by monitoring the movement vector set of the skeleton representation of the occupant depicting the personalized motions performed by the occupant, computed from a training video captured by the camera. One or more parameters of the occupant profile of the occupant are detected, for example, by sensors, manual user entry, and/or analysis of images. A record comprising a sequence of personalized motions performed by the occupant as depicted in the movement vector set of the skeleton representation, is created. The ground truth label of the record indicates the one or more parameters of the occupant profile. The personalized ML model is trained on the record(s). The records may be iteratively obtained, for example, why the driver is operating the vehicle, in order to learn to predict which motions the occupant performs prior to adjusting the occupant profile, to enable real time adjustment of the vehicle parameters according to the occupant profile based on the monitored motions prior to the user performing the adjustment themselves.

At least some implementations of the systems, methods, computing devices, and/or code instructions (stored on a data storage device and executable by one or more processors) described herein address the technical problem of detecting an unsafe action by an occupant of a vehicle before the unsafe action is performed. At least some implementations of the systems, methods, computing devices, and/or code instructions (stored on a data storage device and executable by one or more processors) described herein improve the technology of ML models, by detecting an unsafe action by an occupant of a vehicle before the unsafe action is performed. The unsafe action may distract the driver from driving, which increases risk of an accident. For example, a driver handling a mobile phone during driving is distracted from the road, and cannot stop in time to avoid hitting the car in front that suddenly pressed the brakes. Generating feedback to the driver to avoid performing the unsafe action may help the driver maintain their attention to the road. At least some implementations of the systems, methods, computing devices, and/or code instructions (stored on a data storage device and executable by one or more processors) improve the technical field of road safety.

At least some implementations of the systems, methods, computing devices, and/or code instructions described herein address the aforementioned technical problem, and/or improve the aforementioned technology, by using a personalized ML model to predict performance of unsafe actions by the driver before the driver performs the unsafe action. A warning may be generated, which may cause the driver to change behavior to avoid performing the unsafe action. For example, a warning is generated to a driver about to reach the phone to check an SMS message, which causes the driver to look at the road and avoid checking the SMS message.

Predicting personal movements of the driver using movement vector sets of skeleton representations may enable a broader and/or more accurate prediction of unsafe actions about to be performed by the driver that may endanger safety. The personal anomalous movements may enable a broader and/or more accurate prediction of unsafe actions in comparison to using images and/or defined features which may be of a general nature, for example, looking away, holding a phone to the car, bowing the head, and the like. Personal movements of the driver that are performed prior to performance of unsafe actions may be automatically learned, and then used to identify future personal movements to predict imminent performance of unsafe actions. Personal movements of the driver do not necessarily have to be defined in advance, since they are learned by monitoring the driver. Such personal movements of the driver may not be obtainable from other subjects, since they may be unique to the driver.

At least some implementations of the systems, methods, computing devices, and/or code instructions described herein improve upon other approaches for detecting unsafe actions by drivers, for example, monitoring pupils of the driver, and/or monitoring the face of the driver:
The prior approaches may be based on predefined parameters, which may be determined generally from multiple drivers. Such approaches fail to identify personal movements unique to each driver. The generic movements are less accurate in determining unsafe actions. In contrast, at least some embodiments described herein learn personal movements of the driver which are predictive of unsafe actions, improving the accurate of predicting unsafe actions based on the personal movements.
The prior approaches may have blind spots and/or situations in which monitoring cannot be performed, such as when the pupils of the driver cannot be seen. In contrast, at least some embodiments described herein utilize images of the whole body of the driver, which reduce and/or avoid blind spots.
The prior approaches may exclude certain people, for example, pupil monitoring cannot be used to monitor drivers wearing glasses. In contrast, at least some embodiments described herein may be used to monitor any driver.
The prior approaches may require cooperation by the driver, which may make them easy to manipulate. In contrast, at least some embodiments described herein do not require cooperation by the driver, which makes them difficult to manipulate.
The prior approaches may have a long response time, and/or may generate a response after the unsafe action has already been performed, for example, in an effort to stop the unsafe action and/or renew the driver's attention to the road. In contrast, at least some embodiments described herein may predict the unsafe action prior to performance of the unsafe action, which may prevent the unsafe action from occurring at all. The unsafe action may be predicted with a short response time, enabling the prediction before the unsafe action has occurred.

Potential advantages of at least some embodiments described herein include:
Alerting drivers for unsafe interactions with a mobile device, such as smartphone and/or tablet. The driver may be alerted prior to the driver interacting with the mobile device, which may prevent the unsafe interaction from occurring.
The system described herein may be installed in any vehicle, for monitoring any driver, for any unsafe action. Driver intervention is not necessarily required.
Full body and/or surrounding may be monitored. Blind spots may be avoided.
Personal movements performed by the driver prior to performing unsafe actions may be learned, which may allow real time alerts without significant latency, to prevent or reduce risk of the driver performing the unsafe action. The driver may be trained to avoid unsafe actions, which increases driving safety.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

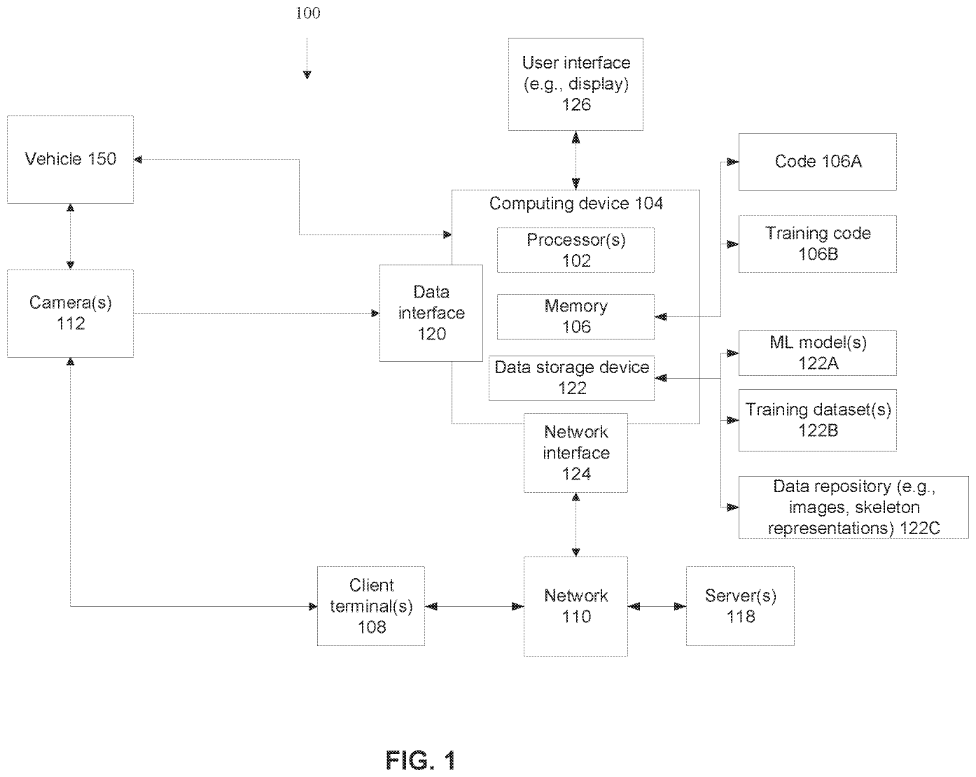

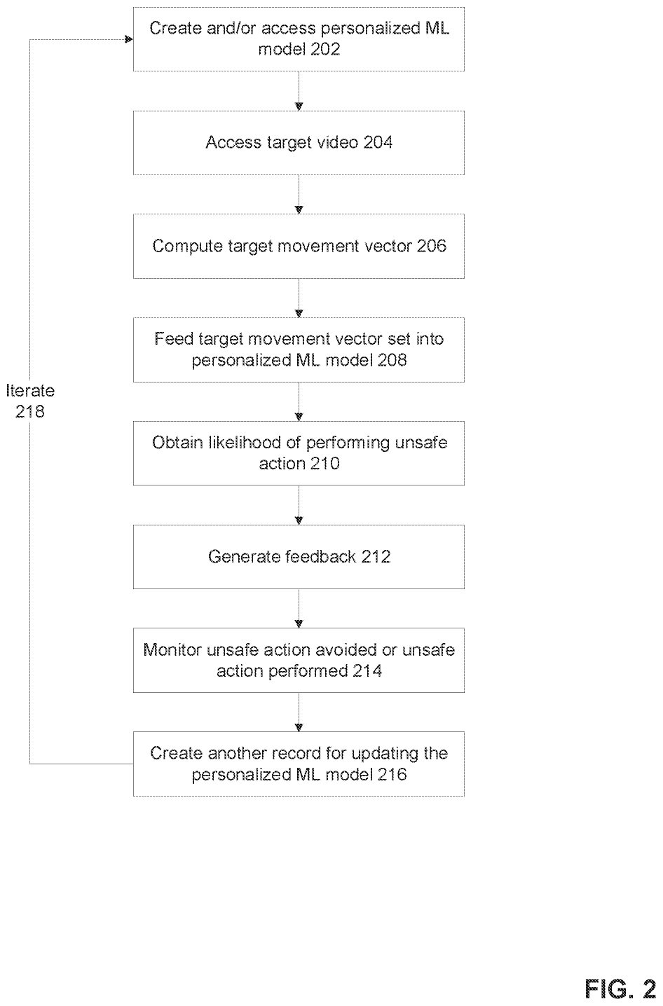

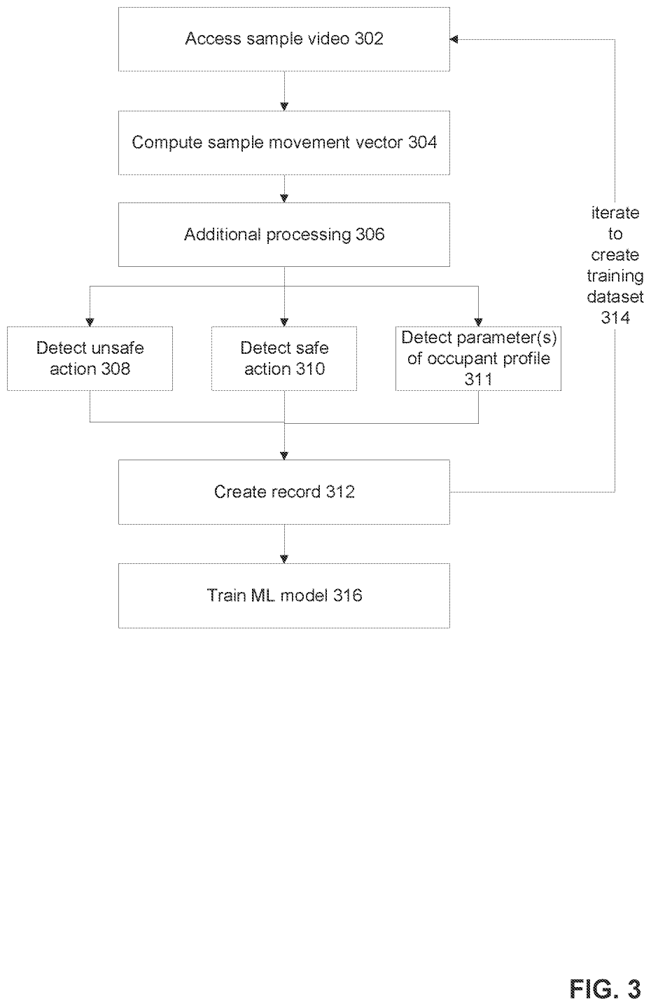

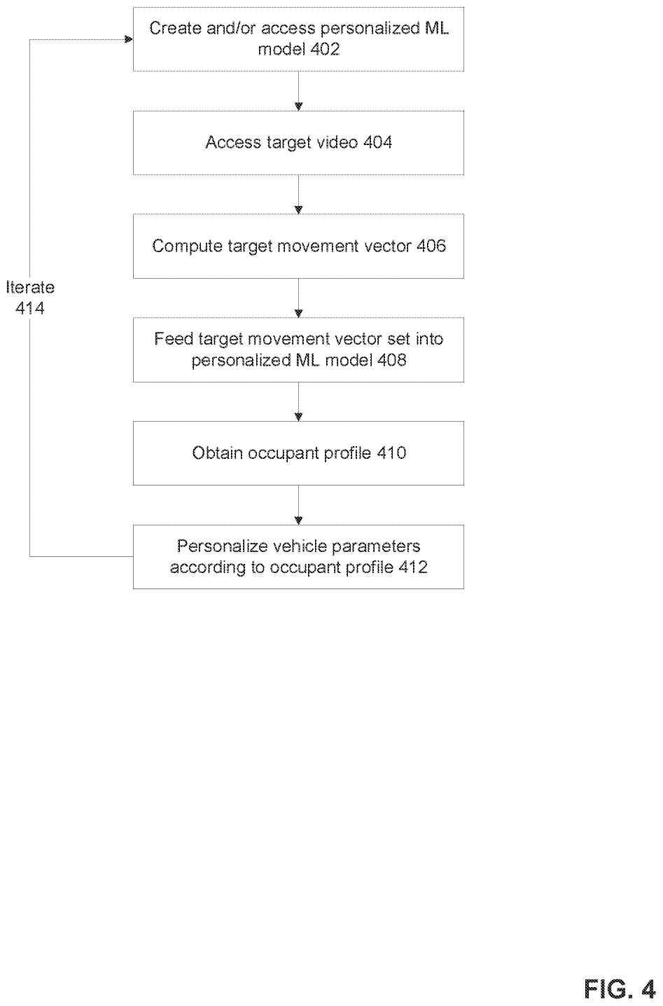

Reference is now made to FIG. 1, which is a block diagram of components of a system 100 for monitoring an occupant of a vehicle for predicting an unsafe action, and/or for training a personalized ML model(s) for predicting the unsafe action, in accordance with some embodiments of the present invention. Reference is also made to FIG. 2, which is a flowchart of a method for monitoring an occupant of a vehicle for predicting an unsafe action, in accordance with some embodiments of the present invention. Reference is also made to FIG. 3, which is a flowchart of a method for training a personalized ML model(s) for predicting the unsafe action, in accordance with some embodiments of the present invention. Reference is also made to FIG. 4, which is a flowchart of a method for personalizing a vehicle for an occupant, in accordance with some embodiments of the present invention.

System 100 may implement the acts of the method described with reference to FIGS. 2-4, optionally by a hardware processor(s) 102 of a computing device 104 executing code instructions stored in a memory 106.

Computing device 104 may be installed within a vehicle 150, for example, optionally a road based vehicle, for example, a car, a truck, a van, a minivan, and a bus. The vehicle may be an autonomously driven vehicle, a manually driven vehicle, or a semi-autonomous semi-manual driven vehicle.

Computing device 104 may be implemented, for example, as a hardware component (e.g., installed in vehicle 150), as code instructions installed on one or more existing electronic control units (ECUs) where the code instructions are executed by the hardware processor(s) of the existing ECU, as a portable computing unit that may be used for other purposes, for example, a mobile device (e.g., Smartphone, tablet computer, laptop computer, glasses computer, and watch computer), and/or as an external computing device (e.g., server) location outside of the vehicle in wireless communication with a computing device located within the vehicle. Computing device 104 may be installed as an integrated component within vehicle 150, as a removable component of vehicle 150, and/or as an external component to vehicle 150.

Computing device 104 may be in communication with one or more cameras 112 installed within the vehicle. Cameras 112 may capture video and/or multiple still images, which are analyzed by computing device 104 to predict unsafe action. Cameras 112 may include a visible light sensor, thermal camera, and the like. Camera 112 may be installed as described herein.

Different architectures based on system 100 may be implemented.

In an example architecture, computing device 104 provides localized services. For example, computing device 104 includes code locally stored and/or locally executed by processor(s) 102 installed in the vehicle, for example, within an ECU of the vehicle, within another hardware component within the vehicle, and/or by a mobile device of a user in communication with camera 112. In some embodiments, the mobile device acting as computing device 104 may monitor the driver to determine unsafe interaction with the mobile device. Computing device 104 may locally compute skeleton representations from video captured by camera 112, and/or may locally compute the movement vector set, and/or may locally analyze the movement vector set such as by feeding into a personalized ML model(s) 112A, as described herein. Computing device 104 may locally generate an alert when unsafe actions are predicted, for example, for presentation on a user interface 126 (e.g., display) and/or playing audio on the user interface (e.g., speakers). Computing device 104 may locally train and/or compute personalized ML model(s) 122A using movement vector sets of skeleton representations computed from images (e.g., stored in data repository 122C) captured by camera 112 and/or using training dataset(s) 122B created as described herein.

In another example architecture, computing device 104 provides centralized services. In another example architecture, one or more features may be performed locally and/or one or more features may be performed centrally. For example, client terminal 108 may be locally installed in the vehicle (e.g., ECU, hardware, code, and/or a mobile device) and in communication with camera 112. Client terminal 108 may communicate with computing device 114 over a network 110, for example, computing device 114 is implemented as a server and/or computing cloud. Client terminal 108 may send images captured by camera 112 to computing device 104, and obtain back an indication of whether the unsafe action is predicted. Alternatively or additionally, client terminal 108 may locally perform one or more computational tasks, with the other tasks being performed centrally by computing device 104. For example, client terminal 108 locally computes the skeletal representation and/or the movement vector set, and sends the skeletal representation and/or the movement vector set to client terminal 104 for analysis. This implementation may preserve privacy of the user, since features depicting the face of the driver and/or images of the face of the driver.

Computing device 104 may perform training of one or more personalized ML models 122A for different drivers, as described herein. Alternatively, training is performed by another computing device, and inference is centrally performed by computing device 104. For example, the other computing device locally trains the personalized ML model and computing device 104 centrally feeds the movement vector sets into the personalized ML model of the driver being monitored. The outcome of the analysis (e.g., prediction of imminent unsafe action) may be provided, for example, to client terminal(s) 108 for generation of feedback to the driver, for example, presentation on a display and/or playing over speakers. In another example, computing device 104 provides centralized training and/or computation of the personalized ML model(s) 122A, using movement vector sets and/or skeleton representations computed from images of different drives locally captured by camera(s) 112 installed in different vehicles 150. Respective generated personalized ML models 122A may be provided to the corresponding remote devices (e.g., client terminal(s) 108) for local inference.

In an exemplary implementation, camera 112 may include an interface for connecting to computing device 104, for example, to the ECU, smartphone, laptop, other mobile device (e.g., watch computer), tablet and the like. The interface may be, for example, via a wireless connection (e.g., short range wireless connection), cable (e.g., USB), over a home network, and the like. Such architecture may enable a driver to monitor themselves in their vehicle using camera 112 and a smartphone of the driver. Smartphone may locally compute the movement vector set from images captured by camera 112, and/or may locally analyze the movement vector set to predict imminent performance of the unsafe action, prior to the unsafe action being performed by the driver. The smartphone may generate an alert to the driver to prevent the unsafe action, for example, playing an audio message, generating a beep, and/or flashing a warning on the screen.

Computing device 104 may receive images captured by camera 112 using one or more data interfaces 120, for example, a wire connection (e.g., physical port), a wireless connection (e.g., antenna), a local bus, a port for connection of a data storage device, a network interface card, other physical interface implementations, and/or virtual interfaces (e.g., software interface, virtual private network (VPN) connection, application programming interface (API), software development kit (SDK)).

Processor(s) 102 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include one or more processors (homogenous or heterogeneous), which may be arranged for parallel processing, as clusters and/or as one or more multi core processing units.

Memory 106 (also referred to herein as a program store, and/or data storage device) stores code instruction for execution by hardware processor(s) 102, for example, a random access memory (RAM), read-only memory (ROM), and/or a storage device, for example, non-volatile memory, magnetic media, semiconductor memory devices, hard drive, removable storage, and optical media (e.g., DVD, CD-ROM). For example, memory 106 may store code 106A that implement one or more acts and/or features of the method described with reference to FIGS. 2-4 and/or training code 106B that trains one or more of the ML models described herein.

Computing device 104 may include a data storage device 122 for storing data, for example, one or more ML models 122A, including the personalized ML model, as described herein and/or one or more training datasets 122B and/or data repository 122C storing images, skeletal representations and/or movement vector sets, as described herein. Data storage device 122 may be implemented as, for example, a memory, a local hard-drive, a removable storage device, an optical disk, a storage device, and/or as a remote server and/or computing cloud (e.g., accessed over network 110). It is noted that 122A-C may be stored in data storage device 122, with executing portions loaded into memory 106 for execution by processor(s) 102.

ML models 112A described herein, including the personalized ML model, may be implemented using a suitable architecture designed to process movement vector sets, skeleton representations, and/or images, for example, one or more neural networks of various architectures (e.g., detector, convolutional, fully connected, deep, U-net, encoder-decoder, recurrent, graph, and combination of multiple architectures).

Computing device 104 may include a network interface 124 for connecting to network 110, for example, one or more of, a network interface card, a wireless interface to connect to a wireless network, a physical interface for connecting to a cable for network connectivity, a virtual interface implemented in software, network communication software providing higher layers of network connectivity, and/or other implementations. Computing device 104 may access one or more remote servers 118 using network 110, for example, to obtain and/or provide training dataset(s) 116, an updated version of code 106A, training code 106B, and/or model(s) 122A.

It is noted that data interface 120 and network interface 124 may exist as two independent interfaces (e.g., two network ports), as two virtual interfaces on a common physical interface (e.g., virtual networks on a common network port), and/or integrated into a single interface (e.g., network interface).

Computing device 104 and/or client terminal(s) 108 and/or server(s) 118 include and/or are in communication with a user interface(s) 126 that includes a mechanism designed for a user to enter data and/or present and/or play alerts. Exemplary user interfaces 126 include, for example, one or more of, a touchscreen, a display, a keyboard, a mouse, and voice activated software using speakers and microphone.

Referring now back to FIG. 2, at 202, a personalized ML is created and/or accessed and/or selected. The personalized ML model may be dynamically updated, by dynamically creating records while the occupant is being monitored. The personalized ML model is trained on sequences of personalized motions performed by the occupant prior to the performance of the unsafe action and ground truth labels indicating the unsafe action.

Optionally, the personalized ML model is selected according to an identified occupant profile. The occupant profile may be identified, for example, by a best match between a set of parameters identified for the current occupant the set of parameters of multiple occupant profiles, for example, a highest correlation value, and/or a shortest Euclidean distance between the current set of parameters and the set of parameters of multiple occupant profiles. Examples of parameters used to define the occupant profile include one or more of: position and/or orientation of seats, selected temperature, selected music (e.g., selected radio station, selected type of music), automatically recognizing the occupant using facial recognition software, and/or according to user credentials that the occupant provides. Alternatively or additionally, once the occupant profile is identified (e.g., using facial recognition and/or the user enters the credentials), one or more of the parameters are automatically set to the values in the occupant profile. The occupant profile may be used for other settings, for example, automatic payment (e.g., tolls, rental car fees, gas), charging a battery of an electric vehicle, access to data, and/or playing a playlist created for the occupant and/or selected by the occupant over speakers of the vehicle.

A respective personalized ML model may be created per occupant profile. There may be multiple different occupant profiles, optionally per vehicle. Each occupant profile is associated with a certain personalized ML model. For example, a respective personalized ML model is created for each driver of the vehicle, and/or each passenger of the vehicle, which may be known repeated occupants of the vehicle. The personalized ML model selected according to the occupant enables distinguishing motions that are unsafe for one occupant, but safe for another occupant. For example, for one person driving with one hand on the steering wheel is routine, and done safely. For another person, driving with one hand is unusual and may indicate unsafe actions, for example, the person usually drives with two hands on the steering wheel, and removes one hand from the wheel when the person interacts with their phone. In such as case, detecting removal of one hand from the steering wheel indicates that the person is about to touch their phone.

An exemplary process of training the personalized ML model is described, for example, with reference to FIG. 3.

At 204, a target video is accessed. The target video may be continuously generated and/or streamed, in which case, the target video may be dynamically analyzed as it is captured and/or portions of the target video may be analyzed, for example, frames within a sliding window and/or sequential windows, which may be of a size of about half a second, or one second, or two seconds, or other values.

The camera may be installed for monitoring one or more occupants of the vehicle, for example, the driver, one or more passengers, a baby in a car seat, and the like.

The camera may be oriented towards a side of the occupant.

The camera may be installed at a right corner of a cabin of the vehicle between a windshield and a passenger door, above a head level of a passenger and the driver.

The camera may be set for capturing a full body of the occupant.

The camera may be an independent camera installed in the vehicle, dedicated for monitoring the occupant. Alternatively, the camera may be of a mobile device of the user, which is temporarily placed in the vehicle for monitoring the occupant during driving. For example, the camera is of a smartphone of the driver, which is used to monitor the driver for preventing the driver from touching the smartphone during driving.

At 206, a target movement vector set of a skeleton representation of the occupant is computed from the target video.

When the target video includes the full body of the occupant, the movement vector set of the skeleton representation depicts arms, torso, and legs of the occupant. Optionally, the full body of the occupant includes one or more fingers of the occupant, and the movement vector set of the skeleton representation depicts the one or more fingers of the occupant. The fingers may be analyzed to determine whether the driver is holding and/or touching the object, and/or whether the driver is just about to hold and/or touch the object.

The movement vector set of a skeleton representation may be computed, for example, by: 1. Obtaining the skeleton representation: A computer vision technique such as OpenPose or Kinect may be used to extract a 2D or 3D skeleton representation of the occupant from the video. 2. Tracking the skeleton over time: Once the skeleton representation for each frame in the video is obtained, the movement of the skeleton over time is tracked. A tracking algorithm such as Lucas-Kanade or optical flow may be used to track the positions of the skeleton joints in each frame. 3. Calculate the movement vectors: For each pair of frames, the movement vectors between the corresponding joints in the two frames may be calculated. A set of movement vectors that represent the motion of the skeleton over time is obtained. 4. Normalizing the movement vectors: Depending on the length and speed of the movements, the movement vectors may have different magnitudes. To make them more comparable, the vectors may be normalized by dividing them by their length. 5. Represent the movement vectors: The movement vectors may be represented as a set of features for further analysis. For example, using statistical techniques such as principal component analysis (PCA) and/or clustering algorithms to analyze the movement patterns and identify different types of movements.

At 208, the target movement vector set of the target skeleton representation is fed into the personalized ML model.

Alternatively or additionally, other data is obtained and fed into the personalized ML model in combination with the target movement vector, for example, measurements of one or more sensors, which may be monitoring the state of the vehicle and/or monitoring the occupants. Exemplary data obtained from sensors include: indication of which occupants are wearing seat belts and/or which occupants are not wearing seat belts obtained from seat belt sensors, pressure applied to seats on which occupants may or may not be sitting by a pressure sensor, where pupils of occupants are gazing by a pupil gaze sensor, speed of the vehicle by a speed sensor, bright lights from outside which may blind the driver by a light sensor (e.g., from the sun, from high beam headlights by an oncoming vehicle), location of wheel (e.g., straight, turning), and/or whether one or both hands of the occupant are on the wheel (e.g., by a pressure sensor and/or by analyzing the video). The additional data may increase the accuracy of detecting impending unsafe actions, for example, by providing the state of the vehicle prior to performance of the unsafe action. The occupant may be more likely to perform the unsafe action during certain states of the vehicle, for example, when the vehicle is moving quickly, and/or when no seat belt is being worn.

Optionally, privacy of the occupants may be preserved, for example, by not feeding features enabling recognizing the face of the occupants into the personalized ML model. For example, the face and/or other identification features may be blurred in the video, and/or excluded from further processing. The blurring and/or exclusion may be performed for example, during implementation of features 204, 206, and/or 208 of FIG. 2.

Alternatively, the occupants may be identified by unique feature of their faces and/or other unique features as described herein. The facial features and/or other unique features may be used for training the personalized ML model, and/or fed into the personalized ML model. The occupants may select whether they grant access to their personal facial features or whether they want privacy and deny access to their facial features. Feeding facial features into the personalized ML model may enable use of the facial features to help predict unsafe actions, and/or predict other states, for example, whether the driver is in control of the vehicle, whether the driver is in distress (e.g., scared, nervous) such as the driver is witnessing an accident ahead on the road, and/or medical state of the occupants (e.g., sudden heart attack and/or stroke).

Optionally, the target movement vector set depicts the occupant prior to performance of an unsafe action.

Optionally, the sequence of motions fed into the personalized ML model exclude a depiction of an object and/or exclude an explicit location of the object. The object may be an object correlated with the unsafe action (e.g., touching the object and/or interacting with the object may increase risk of an accident), for example, a phone, a cigarette, a coffee cup, a book, and the like. Detection of an unsafe action, for example, touching the object, may be done without detecting the object itself, and/or without consideration of where the object is located. Alternatively or additionally, the sequence of motions of the record depict the occupant touching the object. The outcome of the personalized ML model is generated in response to the driver touching the object depicted in the target movement vector set fed into the personalized ML model.

Optionally, detection of the unsafe action in which the occupant is interacting with the object, and/or prior to the occupant interacting with the object, is based on analyzing motion of the occupant's fingers interacting with the object. The motion of one or more fingers may be analyzed to determine whether the driver is holding and/or touching the object, and/or whether the driver is just about to hold and/or touch the object.

Optionally, objects may be detected and/or tracked. For example, the driver may take out their phone, and place it on the left side, in an attempt to hide the phone from the camera. The phone may be detected and tracked, such that the presence of the phone is known, even while hidden. A warning to the user may be presented, for example, a hidden phone is detected. Do not touch the hidden phone while driving. Optionally, the objects may be tracked to determine whether an occupant has forgotten the object after they have exited the vehicle. In response to detecting that the object has been forgotten in the vehicle, an action may be triggered, for example, message may be sent to a mobile device of the occupant, and/or a reminder alert not to forget the object may be generated in the vehicle just prior to the occupant existing and/or while the occupant is existing, for example, played on speakers of the car and/or presented on a display. The object may be, for example, the phone, wallet, and/or child in a car seat.

At 210, a likelihood of the occupant about to perform an unsafe action is obtained as an outcome of the personalized ML model. The likelihood of the occupant about to perform the unsafe action may be obtained prior to the occupant performing the unsafe action.

Examples of unsafe actions performed by the occupant include driving while: drunk, high on drugs, tired, stressed, agitated, anxious, nervous, uncomfortable, and for long periods of time without a break.

Examples of unsafe action performed by the occupant, optionally a driver include: using and/or touching a mobile device, reading, drinking, eating, taking hands off a wheel, forgetting an object in the vehicle, and turning a head away from the road.

Examples of unsafe action performed by the occupant, optionally a passenger include: disturbing the driver, touching the steering wheel, touching the gears, putting a hand out the window, and placing feet on the dashboard.

Other examples of unsafe actions performed by the occupant include: leaving a child in the car after occupants have exited the car, unsafe seating position, unruly behavior, detected carjacking, detected criminal acts, physical attack by one occupant on another occupant, and emergency medical state (e.g., stroke, heart attack, chocking).

Examples of personalized movements performed by the which may predict unsafe actions, include: moving a hand towards a phone, and seating posture.

The outcome generated by the ML model may include, for example, a classification category (e.g., binary) indicating whether an unsafe action is about to occur or not, a probability of likelihood of the unsafe action about to occur, a time frame during which the unsafe action is about to occur (e.g., in the next 3-5 seconds, or in the next 1-5 second), and the like.

At 212, instructions for a feedback implemented by a user interface device may be generated in response to the outcome. The feedback may be generated prior to the occupant performing the unsafe action, which may prevent the occupant from performing the unsafe action.

Examples of feedback include an audio message played over speakers, a pop-up message appearing on the display of the dashboard, an image and/or video appearing on a smartphone of the occupant located in the vehicle, and the like. The feedback may be provided to the smartphone of the occupant, optionally when the feedback itself is a warning to the driver not to touch the smartphone during driving. For example, in response to detecting that the driver is about to touch the smartphone, the smartphone may present a warning message on its display and/or may play a warning message on its speaker.

Alternatively or additionally, instructions for automatic adjustment of one or more vehicle settings are automatically generated based on outcome(s) of the personalized ML model. The personalized ML model may further indicate which vehicle settings to adjust as another outcome (or as the outcome instead of the likelihood of unsafe action). The instructions may be for reducing likelihood of the occupant performing the unsafe action, such as by enhancing the driving experience and/or improving the state of the vehicle to increase the attention of the driver. The instructions may be, for example, adjusting settings of side view mirrors, automatically activate windshield wipers, turn down (of off) volume of the radio, turn off other displays, adjusting air bags (e.g., adjusting the trigger(s) for the airbag, turn off airbag for child in front seat), adjust setting of seat(s) (e.g., position such as forward, reverse, tilt, headrest angle, headrest height, lumbar support, seat heating), and the like. The personalized ML model may be trained accordingly, using records that include the motion and a ground truth of a change in vehicle setting performed by the occupant.

Optionally, the movements made by the occupant may be personalized motions which correspond to instructions for adjustment of vehicle settings. For example, the driver may point to the right, and in response, the right turn signal is activated. In another example, the driver may move their index finger in a back and form arc motion, and in response, the windshield wipers are activated. The personalized ML model may be trained accordingly, using records that include the personalized motion and a ground truth of the desired activation of vehicle setting.

At 214, the response of the occupant to the feedback may be monitored, for example, by iterating features described with reference to 204-210. The outcome of the personalized ML model may be monitored to determine whether the occupant followed the feedback and avoided performing the unsafe action, or ignored the feedback and did perform the unsafe action.

Optionally, in response to obtaining an indication of the driver performing the unsafe action, instructions for execution by one or more components of the vehicle may be generated. For example, the hazard lights of the vehicle may be automatically activated (without requiring the use to press the hazard warning light button) for warning individuals outside of the vehicle. In another example, performance of the unsafe action may be reported to an external computing device, for example, the unsafe action may be logged in a log file by an onboard computer, and/or a message indicating the unsafe action may be transmitted by the onboard computer over a wireless network connection (e.g., cellular connection) to a device located externally to the vehicle, for example, an administrative server that monitors a fleet of cars (e.g., rental company, corporate vehicles, delivery vehicles, taxis, insurance company, and the like). A statistical report may be created based on the logged data, for example, number of unsafe actions, number of feedback warnings adhered to, and/or number of feedback warnings ignored, which may be per driving hour, per week, and/or per 100 kilometers of driving. In another example, the phone in the vehicle may be automatically connected to an emergency call center, for example, police, fire, ambulance, and the like. For example, when an attack by a passenger on the driver is detected, the police may be called. When a child is detected as being left along in the car, the fire department may be called. When the occupant is detected as having an emergency medical condition (e.g., stroke, heart attack), an ambulance may be called.

At 216, a record may be created for dynamically updating the personalized ML model. The record may include the sequence of motions performed by the movement vector set of the skeleton representation, prior to the generation of the feedback, and the ground truth label indicating avoidance of the unsafe action, or the ground truth label may indicate performance of the unsafe action.

The record may include the type of feedback provided, which may be analyzed for example, for selecting the type of feedback according to the occupant and/or according to the predicted unsafe action, for increasing likelihood of compliance by the occupant in avoiding the unsafe action.

Creation of records prior to the detection of the unsafe action is described with reference to FIG. 3.

At 218, one or more features described with reference to 202-216 may be iterated.

Optionally, creating records and dynamically updating the personalized ML model is performed substantially simultaneously, and/or sequentially and/or alternatively, with inference by the trained personalized ML model. For example, the same video may be used for inference and for training.

Optionally, one or more iterations are for monitoring the occupant without generating feedback (i.e., when no unsafe action is predicted), one or more iterations are for generating the feedback, and one or more iterations are for monitoring the occupant after the generated feedback, as described herein.

Optionally, data may be collected and/or logged during the iterations. Data may be collected and/or logged from multiple vehicles, for one or more occupants in each vehicle. The data may include one or more of: the motions of the occupants, state of the vehicle (e.g., based on sensor data measurements as described herein), predictions of unsafe actions, generated feedback, response to occupants to the feedback, number of occupants per vehicle, location of occupants within the vehicle, and the like. The collected and/or logged data may be analyzed, for example, for designing feature of autonomous vehicles, designing a more ergonomic interior car environment for the occupants such as for increasing safety by reducing likelihood of occupants performing unsafe actions, and the like. In another example, the collected and/or logged data may be analyzed for optimally selecting parameters of the vehicle for reducing damage to the vehicle and/or to the occupants during accidents and/or for reducing risk of accidents, for example, direction of air bags for each occupant, volume of air bag for each occupants, and/or angle of the airbag for each occupant.

Optionally, data is collected for multiple iterations, of the same occupant and/or different occupants, of the same vehicle and/or different vehicles. The data may be used, for example, to analyze impact of different factors on the occupants. Examples of factors include: use of medication while operating the vehicle, wearing of sunglasses while operating the vehicle, and the like. For example, for a first group some iterations may be obtained without the application of the factor, and for a second group other iterations are obtained with application of the factor. The impact of the application of the factor on movement of occupants, safety impact, and the like may be analyzed, for example, by statistically comparing the target movement vectors, unsafe actions, and/or other outcomes described herein, between the groups.

Referring now back to FIG. 3, at 302, a sample video of the occupant is accessed. The sample video may be a training for training, and/or may be the target video which is being analyzed as described with reference to FIG. 2.

The sample video may be accessed, for example, as described with reference to 202 of FIG. 2.

At 304, the movement vector set of the skeleton representation of the occupant is computed, for example, as described with reference to 204 of FIG. 2. The movement vector set may depict the personalized motions performed by the occupant.

At 306, additional processing may be done. The additional processing may be of the video and/or the movement vector set.

The additional processing may including analyzing the video for detecting an object. The object may be an object correlated with the unsafe action (e.g., touching and/or interacting with the object may increase risk of an accident), for example, a phone, a cigarette, a coffee cup, a book, and the like. Other examples of objects include: shoulder rest, and head rest.

The additional processing may including removal of features enabling recognizing a face of the occupant. For example, the face of the occupant is blurred out, and/or excluded from further processing and/or are not included in the record, such as not feeding. Other unique features enabling identification of the occupant may be removed, for example, a unique object handing from the rearview mirror, a unique cover of the steering wheel, and the like. Alternatively, the additional processing may include extraction of facial features of the occupant and/or other uniquely identifying features. For example, boundary boxes around the face of the occupant are automatically detected and extracted.

The additional processing may include obtaining measurements of sensors, and/or computing values based on the sensor measurements. Exemplary values and sensors are described with reference to 208 of FIG. 2.

At 308, an unsafe action performed by the driver is detected.

Optionally, the unsafe action is automatically detected, for example, by an unsafe ML model trained for analyzing movement vector sets of skeleton representations of occupants for detecting unsafe actions. The unsafe ML model may be trained, for example, on a training dataset of records each including a movement vector set of skeleton representation of a sample occupant and a ground truth label indicating the unsafe action. Since unsafe actions are common, the unsafe ML model may be trained on videos of different occupants, which may be real and/or “fake” (e.g., actors mimicking unsafe actions). In another example, other approaches may be used to detect unsafe actions, for example, image processing approaches that detect an object, detect a hand of a person, and detect the unsafe action when the hand touches the object.

Optionally, a ground truth label is automatically created based on the automatically detected unsafe action.

Alternatively or additionally, the unsafe ML model indicates that no unsafe action is detected.

The ground truth label may be, for example, a classification category indicating unsafe action in general, and/or a specific classification category indicating which type of unsafe action is detected, and/or whether no unsafe action is detected.

The unsafe ML model may detect a certain type of unsafe action, in which case multiple unsafe ML models may be executed to detect the different types of unsafe actions. In another example, the unsafe ML model is trained to detect multiple different unsafe actions.

Alternatively to 308, at 310, a safe action performed by the occupant is detected. The safe action may be detected by the unsafe ML model according to other parameters (e.g., whether the vehicle is moving or stopped, and/or whether the occupant is a driver or passenger), and/or by a safe ML model trained for analyzing movement vector sets of skeleton representations of occupants for detecting safe actions.

It is noted that lack of the unsafe action being detected is different from a safe action being detected. For example, the unsafe action may be the same as the safe action, with the difference being whether the vehicle is stopped or not, and/or whether the occupant being monitored is the driver or passenger. When the vehicle is moving and/or when the occupant is the driver, touching the smartphone and/or drinking a cup of coffee may be labelled as unsafe actions. Whereas touching the smartphone and/or drinking a cup of coffee may be labelled as unsafe actions when the vehicle is stopped and/or when the occupant is a passenger. In another example, safe action is a permitted action which may appear similar to an unsafe action, for example, the occupant reaching to change the volume of the radio, changing gears, and/or activating other functions allowed during driving.

Alternatively or additionally to 308 and 310, at 311, one or more parameters of the occupant profile of the occupant are detected, i.e., one or more parameters of the vehicle are detected. For example, radio station, volume, type of music, tilt of steering wheel, adjustment of seat (forward, reverse), temperature of air conditioner, seat lumbar support, and/or location of icons on a display in the vehicle. The parameters of the occupant profile may be detected, for example, by sensors (e.g., the sense position of the charge), outputs of ECUs (e.g., that control the air conditioner), by code (e.g., a browser outputs a network address of a web radio station), by analysis of images captured by the camera, manually entered by a user, and the like.

At 312, a record may be automatically created.

The record includes a sequence of personalized motions performed by the occupant as depicted in the movement vector set of the skeleton representation and the ground truth label.

Different records may be created, depending on what is being depicted, and/or when the action takes place. Examples of records include:

Movement vector set of personalized motions performed by the occupant prior to the performance of the unsafe action. The ground truth label indicating the unsafe action. May be used to detect personalized motions which predict likelihood of the unsafe action about to be performed, prior to the unsafe action being performed.

Movement vector depicting the driver during operation of the vehicle. The unsafe action may be performed by the driver during operation of the vehicle. The ground truth may include another label indicating that the unsafe action is performed during operation of the vehicle. May be used for predicting likelihood of the driver about to perform the unsafe action is while the driver is operating the vehicle.

Movement vector set of personalized motions performed by the occupant during performance of the unsafe action. The ground truth label indicating the unsafe action. May be used to detect performance of the unsafe action while the unsafe action is being performed, for example, to monitor whether the occupant followed a warning and avoided the unsafe action or whether the occupant ignored the warning and performed the unsafe action.

Movement vector set of personalized motions performed by the occupant while the driver is not operating the vehicle, prior to the occupant performing a sample action which is the unsafe action while the driver is operating the vehicle and a safe action when the driver is non-operating the vehicle. The ground truth label indicates a safe action. May be used for detecting the safe action as the outcome of the personalized ML model when the target movement vector set of the target video depicts the driver not operating the vehicle. Examples of the driver not operating include: the driver is stopping the vehicle, and while the vehicle is stopped.

Movement vector set of personalized motions performed by the occupant prior to the performance of the safe action. The ground truth label indicating the safe action. May be used to detect personalized motions which predict likelihood of the safe action about to be performed, prior to the safe action being performed. May be used, for example, to monitor safe actions which may become unsafe actions, for example, the driver is about to touch the phone while the car is stopped (safe action) but then starts to drive while proceeding to touch the phone (unsafe action).

Movement vector set of personalized motions performed by the occupant during performance of the safe action. The ground truth label indicating the safe action. May be used to detect performance of the safe action while the safe action is being performed, for example, to monitor whether the occupant followed a warning and avoided the unsafe action by converting the unsafe action to the safe action. For example, the driver was about to touch the phone while driving (unsafe action), a warning was generated, the driver pulled to the side of the road and stopped the car (conversion of unsafe action to safe action), and the driver touched the phone while the car was stopped (safe action).

Movement vector set of personalized motions performed by the occupant after feedback indicating that the unsafe action is about to occur is generated. May be used to monitor the occupant after feedback, to detect whether the occupant followed the feedback and refrained from performing the unsafe action, or whether the occupant ignored the feedback and performed the unsafe action.

Movement vector set of personalized motions performed by the occupant while a current occupant profile is set in the vehicle, prior to adapting changes to the occupant profile, during adaptation of the occupant profiles, and/or after the occupant profile has been adapted. The ground truth label indicates the parameter(s) of the occupant profile.

The record may exclude features enabling recognizing a face of the occupant and/or other unique identification features, as described herein. For example, images of boundary boxes depicting faces are extracted and included in the record.

The sequence of the movement vector set (which is included in the record) may be prior to the driver interacting with the object. The sequence of the movement vector set may depict one or more fingers of the driver interacting with the object. The ground truth label may indicate the detected object. The sequence of the movement vector set may be used to detect likelihood of the driver about to interact with the object, optionally one or more fingers of the driver about to touch the object.

The record may include a portion of the training video corresponding to the sequence of motions. In such implementation, the target video may be fed into the personalized ML model during inference.

The record may include one or more measurements obtained by sensors and/or one or more values computed from the measurements made by the sensors.

The record may include a personalized motion made by the occupant with a specific meaning, and a ground truth of the desired activation of vehicle setting, for example, motion is pointing to the right, the ground truth is activation of the right turn signal is activated. In another example, the motion is moving an index finger in a back and form arc motion, and the ground truth is activation of the windshield wipers.

The personalized ML model may be trained accordingly, using records that include the motion and a ground truth of a change in vehicle setting performed by the occupant. For example, the driver looks around in a dangerous way, and then adjusts the side mirrors. The side mirror may be automatically adjusted in respond to detecting the driver looking around in the dangerous manner.

At 314, one or more features described with reference to 302-312 are iterated, for creating multiple records. The multiple records may be included within a training dataset.

The records may be created during a training phase, for example, the occupant follows an instruction audio played over speakers, and/or an instruction video played on a display (e.g., of the car, and/or of a smartphone) instructing performing different unsafe actions, optionally in a safe manner such as pretending to drive while the car is stopped. Alternatively or additionally, the records may be created in real time, during an inference phase, while the occupant is being monitored for unsafe actions, additional records may be created, as described herein.

At 314, the personalized ML model is trained on the training dataset.

Optionally, the personalized ML model is created by applying a transfer learning approach. A generic ML model may be further trained on the training dataset, which is personalized for the occupant. The generic ML model may be pre-trained on a generic training dataset of records obtained from other sample occupants performing a same type of unsafe action, for example, actors performing the unsafe actions in a safe manner (e.g., in a simulator and/or while the car is stopped and/or while the car is driving but in a safe environment such as an empty parking lot). The generic ML model may be used to identify general actions performed by sample occupants to predict and/or identify the unsafe actions. The transfer learning approach may teach the generic ML model to identify unique movements of a specific occupant, which are not necessarily performed by the sample occupants, thereby creating the personalized ML model for monitoring the specific occupant for their unique movements.

Referring now back to FIG. 4, at 402, a personalized ML is created and/or accessed and/or selected. The personalized ML model may be dynamically updated, by dynamically creating records while the occupant is being monitored. The personalized ML model is trained on sequences of personalized motions performed by the occupant while a certain occupant profile is set, and/or prior to and/or after the occupant profile has been adapted.

The personalized ML model may be selected according to an identified occupant profile, which may serve as the original trigger for selecting the personalized ML model. The occupant profile may then be dynamically adapted based on outcomes generated by the personalized ML model. Alternatively, the occupant is recognized (e.g., by ID, face recognition, and the like), and the personalized ML model of the occupant is accessed.

A respective personalized ML model may be created per occupant profile. There may be multiple different occupant profiles, optionally per vehicle. Each occupant profile is associated with a certain personalized ML model. For example, a respective personalized ML model is created for each driver of the vehicle, and/or each passenger of the vehicle, which may be known repeated occupants of the vehicle. The personalized ML model selected according to the occupant enables customizing settings of the vehicle for each occupant, optionally in real time while operating the vehicle.

An exemplary process of training the personalized ML model is described, for example, with reference to FIG. 3.

At 404, a target video is accessed, for example, as described with reference to 204 of FIG. 2.

At 406, a target movement vector set of a skeleton representation of the occupant is computed from the target video, for example, as described with reference to 206 of FIG. 2.

At 408, the target movement vector set of the target skeleton representation is fed into the personalized ML model, for example, as described with reference to 208 of FIG. 2.

At 410, an occupant profile for the occupant is obtained as an outcome of the personalized ML model. The occupant profile may include one or more parameters for settings of one or more vehicle features, as described herein.

At 412, instructions for personalizing the one or more parameters of the vehicle for the occupant according to the occupant profile are generated, for example, signals are transmitted to motors of the chair, code is sent to a browser to access a different podcast, and instructions are sent to an ECU of the vehicle to change the temperature of the air conditioner. The parameters of the vehicle are adapted according to the generated instructions.

At 414, one or more features described with reference to 404-412 are iterated. The iterations may be performed while the vehicle is being operated for example, while the driving is driving the vehicle, and/or while the passenger is sitting in the moving vehicles. The iterations may provide real time (or near real time) adaptations of the vehicle according to adaptations of the occupant profile. For example, when the driver is getting tired after a long driving time and makes corresponding motions, the air conditioner's temperature may be reduced in an attempt to wake up the driver. In another example, when the driver reaches a highway, the seat may be moved back to make the highway drive more comfortable. In yet another example, at 5 PM, a music radio station may be changed to a talk show radio station which is enjoyable to the driver.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant ML models will be developed and the scope of the term ML model is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A computer implemented method of monitoring an occupant of a vehicle, comprising:
computing a target movement vector set of a skeleton representation from a target video captured by a camera oriented towards a side of the occupant;
feeding the target movement vector set of the target skeleton representation into a personalized ML model;
obtaining a likelihood of the occupant about to perform an unsafe action as an outcome of the personalized ML model; and
generating a feedback by a user interface device in response to the outcome, the feedback generated prior to the occupant performing the unsafe action, thereby preventing the occupant from performing the unsafe action,
wherein the personalized ML model is trained on sequences of personalized motions performed by the occupant prior to the performance of the unsafe action and ground truth labels indicating the unsafe action.

2. The computer implemented method of claim 1, wherein the personalized ML model for the occupant is created by:
monitoring the movement vector set of the skeleton representation of the occupant depicting the personalized motions performed by the occupant, computed from a training video captured by the camera,
detecting the unsafe action performed by the occupant,
creating a record comprising a sequence of personalized motions performed by the occupant as depicted in the movement vector set of the skeleton representation prior to the performance of the unsafe action, and the ground truth label indicating the unsafe action, and
training the personalized ML model on the record.

3. The computer implemented method of claim 1, wherein the unsafe action is automatically detected by an unsafe ML model trained for analyzing movement vector sets of skeleton representations of occupants, and the ground truth label is automatically created based on the automatically detected unsafe action.

4. The computer implemented method of claim 1, wherein the likelihood of the occupant about to perform the unsafe action is obtained prior to the occupant performing the unsafe action.

5. The computer implemented method of claim 1, further comprising;
creating another record comprising the sequence of motions performed by the movement vector set of the skeleton representation after the generation of the feedback and the ground truth label indicating avoidance of the unsafe action, and
monitoring the outcome of the personalized ML model to obtain the outcome indicating that the occupant has avoided the unsafe action in response to the feedback.

6. The computer implemented method of claim 1, wherein creating the personalized ML model and the feeding, and the obtaining are performed substantially simultaneously, and/or sequentially and/or alternatively.

7. The computer implemented method of claim 1, further comprising:
detecting a safe action performed by the occupant,
creating another record comprising the sequence of motions performed by the movement vector set of the skeleton representation prior to the performance of the safe action, and a ground truth label indicating the safe action; and
training the personalized ML model on the safe action.

8. The computer implemented method of claim 1, wherein the unsafe action is selecting from a group comprising: using and/or touching a mobile device, reading, drinking, eating, taking hands off a wheel, turning a head of the occupant away from the road, disturbing the driver, touching the steering wheel, touching the gears, putting a hand out the window, leaving a child in the car after occupants have exited the car, unsafe seating position, unruly behavior, detected carjacking, detected criminal acts, physical attack by one occupant on another occupant, emergency medical state, and placing feet on a dashboard, driving for long periods of time without a break, forgetting an object in the vehicle, and/or driving while one or more of: drunk, high on drugs, tired, stressed, agitated, anxious, nervous, and/or uncomfortable.

9. The computer implemented method of claim 1, wherein the personalized ML model is created by applying a transfer learning approach by training a generic ML model on a record created for the occupant, the generic ML model trained on a generic training dataset of records obtained from other sample subjects performing a same type of unsafe action.

10. The computer implemented method of claim 1, wherein the movement vector set depicts the occupant during operation of the vehicle, the unsafe action is performed by the occupant during operation of the vehicle, the ground truth further includes a second label indicating that the unsafe action is performed during operation of the vehicle, and the likelihood of the occupant about to perform the unsafe action is while the occupant is operating the vehicle.

11. The computer implemented method of claim 1, further comprising creating another record comprising a sequence of motions performed by the movement set while the occupant is not operating the vehicle, prior to the occupant performing a sample action which is the unsafe action while the occupant is operating the vehicle and a safe action when the occupant is non-operating the vehicle, and a ground truth label indicating a safe action, wherein the safe action is obtained as the outcome of the personalized ML model when the target movement vector set of the target video depicts the occupant not operating the vehicle.

12. The computer implemented method of claim 11, wherein while the occupant is not operating the vehicle comprises at least one of: the occupant is stopping the vehicle, and while the vehicle is stopped.

13. The computer implemented method of claim 1, wherein the camera is installed at a right corner of a cabin of the vehicle between a windshield and a passenger door, above a head level of a passenger and the occupant.

14. The computer implemented method of claim 1, wherein the camera captures a full body of the occupant, wherein the movement vector set of the skeleton representation depicts arms, torso, and legs of the occupant.

15. The computer implemented method of claim 14, wherein the full body of the occupant includes fingers of the occupant, and the movement vector of the skeleton representation depicts one or more fingers of the occupant, and further comprising analyzing the training video for detecting an object, wherein the unsafe action comprises the occupant's fingers interacting with the object, wherein the sequence of a record is prior to the occupant's fingers interacting with the object, wherein the ground truth label further indicates the detected object, wherein the outcome of the personalized ML model is likelihood of the occupant's fingers about to interact with the object.

16. The computer implemented method of claim 15, wherein the record further comprises a portion of the training video corresponding to the sequence of motions, and wherein feeding further comprises feeding the target video into the personalized ML model.

17. The computer implemented method of claim 1, wherein a record excludes features enabling recognizing a face of the occupant, wherein features enabling recognizing the face of the occupant are not fed into the personalized ML model.

18. The computer implemented method of claim 1, wherein the sequence of motions of a record depict the occupant touching an object, and wherein the outcome of the personalized ML model is generated in response to the occupant touching the object depicted in the target movement vector set fed into the personalized ML model.

19. The computer implemented method of claim 18, wherein the sequence of motions of the record and/or fed into the personalized ML model exclude a depiction of the object and/or exclude an explicit location of the object.

20. The computer implemented method of claim 1, further comprising creating another record comprising the sequence of motions performed by the movement vector set of the skeleton representation during the unsafe action and the ground truth label indicating performance of the unsafe action, and in response to obtaining an indication of the occupant performing the unsafe action, generating instructions for execution by at least one component of the vehicle for at least one of: (i) warning individuals outside of the vehicle and (ii) reporting performance of the unsafe action to an external computing device.

21. The computer implemented method of claim 1, further comprising:
identifying an occupant profile of a plurality of occupant profiles, and selecting the personalized ML model from a plurality of personalized ML models, each personalized ML model corresponding to a certain occupant profile.

22. The computer implemented method of claim 1, further comprising:
obtaining measurements by one or more sensors indicating a state of the vehicle and/or monitoring a state of the occupant; and feeding comprises feeding a combination of the measurements and the target movement vector set into the personalized ML model, wherein the personalized ML model is trained on records that include the combination of the measurements and the target movement vector set.

23. The computer implemented method of claim 1, further comprising generating instructions for automatic adjustment of one or more vehicle settings for reducing likelihood of the occupant performing the unsafe action by improving the state of the vehicle to increase attention of the occupant.

24. A computer implemented method of monitoring an occupant of a vehicle, comprising:
creating a personalized machine learning (ML) model for the occupant by:
monitoring a movement vector set of a skeleton representation of the occupant computed from a training video captured by a camera oriented towards a side of the occupant,
detecting an unsafe action performed by the occupant,
creating a record comprising a sequence of motions performed by the movement vector set of the skeleton representation prior to the performance of the unsafe action, and a ground truth label indicating the unsafe action,
training the personalized ML model on the record;
computing a target movement vector set of the skeleton representation from a target video captured by the camera;
feeding the target movement vector set of the target skeleton representation into the personalized ML model; and
obtaining a likelihood of the occupant about to perform the unsafe action as an outcome of the personalized ML model.

25. A computer implemented method of creating a personalized ML model for an occupant of a vehicle, comprising:
monitoring a movement vector set of a skeleton representation of the occupant computed from a training video captured by a camera oriented towards a side of the occupant;
detecting an unsafe action performed by the occupant;
creating a record comprising a sequence of motions performed by the movement vector set of the skeleton representation prior to the performance of the unsafe action, and a ground truth label indicating the unsafe action; and
training the personalized ML model on the record,
wherein a likelihood of the occupant about to perform the unsafe action is obtained as an outcome of the personalized ML model in response to an input of a target movement vector set of the skeleton representation computed from a target video captured by the camera.

26. A computer implemented method of personalizing a vehicle for an occupant, comprising:
computing a target movement vector set of a skeleton representation from a target video captured by a camera oriented towards a side of the occupant;
feeding the target movement vector set of the target skeleton representation into a personalized ML model;
obtaining an occupant profile for the occupant as an outcome of the personalized ML model; and
generating instructions for personalizing one or more parameters of the vehicle for the occupant according to the occupant profile;
wherein the personalized ML model is trained on sequences of personalized motions performed by the occupant and ground truth labels indicating the occupant profile.

27. The computer implemented method of claim 26, wherein the personalized ML model for the occupant is created by:
monitoring the movement vector set of the skeleton representation of the occupant depicting the personalized motions performed by the occupant, computed from a training video captured by the camera,
detecting one or more parameters of the occupant profile of the occupant,
creating a record comprising a sequence of personalized motions performed by the occupant as depicted in the movement vector set of the skeleton representation, and the ground truth label indicating the one or more parameters of the occupant profile, and
training the personalized ML model on the record.

28. The computer implemented method of claim 27, wherein the record includes the sequence of personalized motions performed by the occupant prior to adapting one or more parameters of the occupant profile, and wherein the outcome of the occupant profile obtained from the ML model is obtained prior to the occupant adapting one or more parameters of the occupant profile, and wherein the instructions for personalizing the one or more parameters of the vehicle for the occupant according to the occupant profile are generated prior to the occupant adapting one or more parameters of the occupant profile.

29. The computer implemented method of claim 26, wherein the occupant includes a driver of the vehicle, and wherein the computing, the feeding, the obtaining and the generating are iterated while the driver is driving the vehicle.
